(19) United States
(12) Patent Application Publication
(10) Pub. No.: US 2015/0079916 A1
(43) Pub. Date: Mar. 19, 2015

(54) MOBILE INTERNET RADIO RECEIVER

(71) Applicant: GB GLOBAL TECHNOLOGY OPERATIONS LLC, Detroit, MI (US)

(72) Inventors: Holger Wolf, Essenheim (DE); Thomas Pfeffer, Messel (DE)

(21) Appl. No.: 14/483,918

(22) Filed: Sep. 11, 2014

(30) Foreign Application Priority Data
Sep. 11, 2013 (DE) 102013015161.9

(51) Int. Cl. H04B 1/12; H04B 1/00

(52) U.S. Cl. CPC H04B 1/12; H04B 1/0057
USPC 455/135

(57) ABSTRACT

A mobile internet radio receiver is disclosed which includes a radio interface for internet communication over a cellular mobile phone network. An internet audio signal source selects and outputs a first audio signal. At least one receiver part receives digital and/or analog radio signals, derives a second audio signal identical in content with the first audio signal from the radio signals, and outputs the second audio signal. A compare entity assesses the reception quality of the first and second audio signals, and outputs an audio signal output to which depending on the assessed reception quality, the first audio signal or the second audio signal can be applied.

### CROSS REFERENCE TO RELATED APPLICATION

This application claims priority to German Patent Application No. 102013015161.9 filed Sep. 11, 2013, which is incorporated herein by reference in its entirety.

### TECHNICAL FIELD

The technical field relates to a receiver for internet radio, in particular for mobile use.

### BACKGROUND

Programs which allow a smartphone to be used as a mobile internet radio receiver are known as such. A problem with these programs consists in that they are dependent on receiving the audio signals to be reproduced from the internet via a cellular mobile phone network. The quality with which the mobile phone network can be received is subject locally to wide fluctuations, either because the radio signal of the mobile phone network reaches the location of the receiver via several routes of varying length thus leading to destructive differences, or because the location of the receiver is too remote from the next base station or from the mobile phone network for receiving their signal with sufficient quality. The user of the smartphone on which an internet radio application is running therefore has the problem that when moving with the smartphone in a vehicle, fluctuations in the quality of reception lead to frequent interruptions of car signal reproduction. This is annoying in particular when uninterrupted reception is important in order to listen to the current news, in particular to traffic news.

### SUMMARY

In accordance with the present disclosure a mobile internet radio receiver is proposed which is capable of obtaining internet data via a cellular mobile phone network and, when emitting an audio signal, to compensate at least partially for any shortcomings or interruptions in the reception of signals of the cellular mobile phone network.

According to one implementation of the present disclosure this requirement is met by a mobile internet radio receiver, in particular for use in vehicles. The mobile internet radio receiver includes a radio interface for internet communication via a cellular mobile phone network. An internet audio signal source selector is configured to select an internet audio signal source and to output a first audio signal originating from the selected internet audio signal source. At least one receiver part is configured to receive digital and/or analog radio signals, to derive a second audio signal identical in content with the first audio signal from the radio signals, and to output the second audio signal. The reception quality of the first and second audio signals is evaluated and an audio signal output can be applied depending on the assessed reception quality of the first audio signal or the second audio signal.

According to one implementation of the present disclosure the second audio signal is applied to the audio signal output only for as long as the reception quality of the first audio signal is determined to be insufficient. In other words, this mobile internet radio receiver reverts back to the reception of the digital and/or analog radio signals only as long as internet reception is not up to the required quality.

Conversely the first audio signal may be applied to the audio signal output only for as long as the reception quality of the second audio signal is assessed to be insufficient. In this case therefore internet radio reception is used only as a temporary measure in case reception of the conventional radio signal is not satisfactory.

In order to be able to perform a switch-over when required without this being noticed by the listener, the radio receiver may further include a detector configured to determine whether the first and the second radio signals are identical in content. A determination of whether these signals are identical in content may be based, in particular, on a sender code contained in the radio signal. Such a sender code is known as PI code in conventional analog broadcasting, and as service ID in digital radio.

In the simplest case the reception quality may be assessed for only the first or only the second audio signal, such that if the signal is assessed as being insufficient, a switch-over to the respectively other audio signal is performed regardless of its quality. This assessment alone may be sufficient to reduce the number of interruptions of the audio signal available at the audio signal output. Preferably, however, the reception quality is monitored for all audio signals, both the signal emitted at the audio signal output and the signal which is not emitted, and to perform a switch-over of the emitted audio signal only if the quality of the signal currently not emitted is better than that of the emitted signal.

In particular the reception quality assessment can be configured to detect interruptions or bit errors of the first and the second audio signals and to apply to the audio signal output at least that signal of the two audio signals, which includes the lower interruption or bit error rate.

In particular the reception quality assessment may be configured to detect a change-over of the radio interface from one cell of the mobile phone network to another cell and to switch over to the second audio signal during such a change-over.

Because a time-offset may occur between conventional radio and internet radio, the internet radio receiver according to the present disclosure should include a buffer for at least one of the audio signals in order avoid repetitions or omissions during switch-over of the audio signals. In order to ensure exact synchronization of the audio signals during switch-over and thus avoid that the switch-over becomes audible, a time-offset between the first and the second audio signal is detected, and the buffer is controlled in accordance with the detected time-offset.

A buffer underrun of one of the two audio signals indicates that the respective audio signal is not received at the rate at which it is needed meaning that the reception quality is insufficient. Therefore, in case there a buffer underrun of one of the two audio signals occurs, the audio signal output should have the respectively other audio signal applied to it.

### BRIEF DESCRIPTION OF THE DRAWINGS

The present disclosure will hereinafter be described in conjunction with the following drawing figures, wherein like numerals denote like elements.

FIG. 1 shows a block diagram of a mobile internet radio receiver according to a first implementation of the present disclosure; and

FIG. 2 shows a detail of a receiver according to a second implementation.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

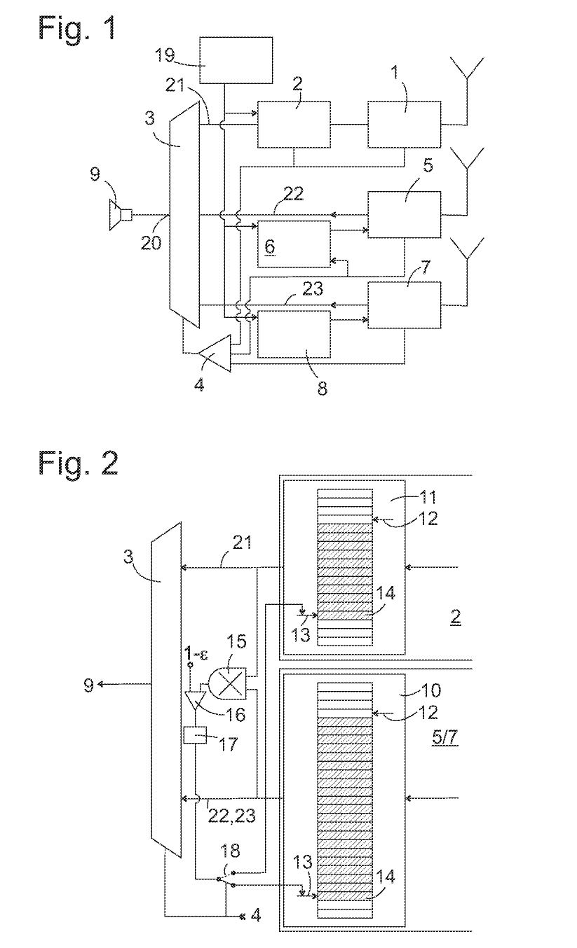

The internet radio receiver of FIG. 1 includes a radio interface 1 for the communication via a cellular mobile phone network, which is configured like the radio interface of a conventional mobile phone, in order to identify a cell of the mobile radio network in which it is residing, in that it receives radio signals of several base stations and compares their quality with each other, and to log in at that base station whose signal can be received with the best quality. The radio interface 1 may be an integral part of the radio receiver, or it may be the radio interface of a car telephone, and in this case would only be available as long as it is not required for telephonic communication. Alternately, it may be the radio interface of a conventional internet-capable mobile phone, also called a smartphone, which is temporarily connected by its user, via a cable or a wireless connection, with components of the radio receiver fixedly mounted in the vehicle for temporary use as a radio interface 1.

The radio interface 1 is connected with an internet client 2 which reports an internet audio signal source selected by a handset at a user interface via the radio interface 1, in order to subsequently receive audio data from this source via the radio interface 1 and to output them as a first audio signal 21 to a multiplexer 3.

A compare entity 4 is connected with the radio interface 1 and/or the internet client 2, in order to receive a signal representative of the quality of the audio signal 21 emitted to the multiplexer 3. One of several approaches for assessing the quality of this audio signal 21 can be employed. The internet client 2 can, for example, base its quality assessment on fluctuations of the time interval lying between the reception of successive data packets of the audio signals at the radio interface 1, or an assessment by the radio interface 1 may be based on the field strength with which the mobile radio signal is received, or on the frequency (ascertained by means of test bits) of bit errors in the received data packets or the failure frequency of packets.

In any case one skilled in the art will recognize that the quality of the mobile radio signal or of the audio signal 21 resulting therefrom is poor independently of the above-mentioned criteria, if the conditions for a hand-over (the changeover of the radio interface 1 from one base station to another base station) are met. In the simplest case the quality assessment by the radio interface 1 includes only 2 values: insufficient in case the conditions for a hand-over are present, otherwise sufficient.

A conventional analog radio receiver part 5 supplies a second audio signal 22 to the multiplexer 3. The tuning frequency of the radio receiver part 5 is fixed by the analog radio control unit 6. This is configured to ascertain a PI code for a transmitter selected by the listener at the user interface, to tune the radio receiver part 5 in order to determine the frequencies on which the transmitter with the cited PI code can be received, and finally to tune the radio receiver part 5 to that frequency on which the respective transmitter with the best quality can be received. In order to select the frequency with the respectively best quality, the control unit 6 is further connected with an output of the radio receiver part 5 which supplies a signal representative of the reception quality of the respectively set transmitter, also to the compare entity 4.

As an alternative to the analog radio components 5, 6 or in combination with these, a digital radio receiver part 7 and a digital control unit 8 are provided for supplying a third audio signal 23 to the multiplexer 3. The control unit 8 is configured to ascertain a transmitter ID (known as service ID in digital radio technology) for the audio signal source, if present, selected at the internet client 2, to select the transmitter with the desired service ID from the transmitters available at the digital radio receiver part 7, and to emit its audio signal as the third audio signal 23 to the multiplexer 3. The digital radio receiver part 7 too supplies a signal to the compare entity 4, which signal is representative of the reception quality of the respectively selected transmitter.

The signals representative of the reception quality are arranged to be comparable with each other by means of appropriate scaling at the compare entity 4. On the basis of the received quality signals the compare entity 4 controls the multiplexer 3, in order to connect respectively one of the audio signals made available by the internet client 2 and the control units 6, 8 via an output 20 of the multiplexer 3 with an output amplifier and loudspeaker 9.

Various strategies are feasible by which the compare entity 4 can select the audio signal to be emitted.

In the simplest case the decision is based merely on the reception quality of the respectively currently emitted audio signal. If this drops below a specified threshold value, the compare entity 4 controls the multiplexer 3 to output another audio signal to the loudspeakers 9. If the quality of this audio signal is better, it is emitted continuously until due e.g. to a movement of the receiver, reception conditions change and the signal quality has again dropped below the threshold value. If the switch-over does not result in the desired improvement in signal quality, a switch-back follows. If the switch-over is repeated several times within a short time span, i.e. if reception is poor both for mobile radio and for analog or digital radio signals, the threshold value may be temporarily lowered in order avoid constant switch-over.

In an alternative, signal quality is continuously monitored on every transmission path so that the compare entity 4 is at any time in possession of quality values both for the transmission via mobile internet and for analog or digital radio. In this case a threshold value may be provided, as above, for the quality of the currently set transmission path, where the prerequisite for a change in transmission path is a drop below the threshold value. A feasible alternative would be for the compare entity 4 to select from the available transmission paths, at any time, that path which has the highest transmission quality.

The selection strategy may prefer one transmission path. For example, if the listener prefers internet transmission, the compare entity 4 may be configured to switch over from internet to radio transmission if the quality of internet transmission drops below a threshold value, i.e. is assessed as being insufficient, but to switch back independently of the quality of the broadcast signal to internet transmission as soon as the quality of the latter is again assessed as being sufficient. This strategy of preference may, of course, also be applied to analog or digital radio reception.

FIG. 2 shows a detail of a mobile internet radio receiver according to a further developed implementation of the present disclosure. The runtimes of an audio signal from the radio transmitter to the mobile receiver for transmission via mobile internet are generally different from the runtimes for direct radio transmission and are normally longer than these. In order to compensate for the time offset between audio signals transmitted via internet and audio signals transmitted via analog or digital radio and in order to make a switch-over between transmission paths inaudible for the listener, the radio receiver part 5 or 7 includes a buffer 10, in which the audio data can be buffered in order to compensate for the different runtimes of radio and internet transmission.

A buffer 11 designed in a similar manner may also be provided in the internet client 2 in order to be able to compensate for any delays during packet transmission via mobile internet.

Both buffers 10, 11 include a write pointer 12 and a read pointer 13, which among the storage cells 14 of buffers 10, 11 denote the storage cell, which is the respectively next cell to which the audio data originating from the radio interface 1 or a receiver part 5 or 7 have to be written to, or the next cell which has to be read and to be outputted by the multiplexer 3, and which are moved cyclically further with each read or write access. The outputs of the two buffers 10, 11 are connected with a cross correlator 15. A control signal from the compare entity 4 determines which of the two buffer outputs is passed on to the loudspeakers 9 via the multiplexer 3. The output value of the cross correlator 15 is the normalized cross correlation of the audio data values successively outputted by the two buffers. When the read pointers 13 of the two buffers 10, 11 are exactly synchronized, then the data outputted by the two buffers 10, 11 is identical save for any transmission or digitizing errors, and the normalized cross correlation continuously calculated between them is essentially constantly equal 1.

If the cross correlation is significantly smaller than 1, i.e. if it drops below a threshold value 1-ε, this is an indication that synchronization between the outputs of buffers 10, 11 no longer exactly matches. This is recorded here by a comparator 16; as long as the threshold value 1-ε is not reached, the comparator 16 keeps a synchronizer 17 active. In its active state the comparator 16 from time to time produces increment and decrement pulses which, via a switch 18 also controlled by the control signal of the compare entity 4, increment or decrement the read pointer 13 of that buffer 10 or 11 which is not switched through to the loudspeakers 9, thus altering the synchronization between the outputs of buffers 10, 11 until the threshold 1-ε of the cross relation is again reached.

When the outputs of the two buffers 10, 11 are synchronized, the multiplexer 3 can continue to alternate between the two buffers 10, 11 without noticeable duplications or omissions occurring in the audio signal for the listener.

Since the signal runtime during transmission over internet and mobile radio network is as a rule longer than during radio transmission, the amount of data held in the buffer 11 is usually smaller than in the buffer 10, and a delay in the transmission of individual packets over the radio path may lead to the buffer 11 idling. By monitoring the data level in the buffer 11 and switching over to buffer 10, i.e. to classical radio reception, in case the data level in buffer 11 drops below the minimum, an interruption of the audio signal emission can be avoided.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-9. (canceled)

10. A mobile internet radio receive for use in a vehicle comprising:
a radio interface configured to receive at least one internet audio signal via internet communication over a cellular mobile phone network, the radio interface having a selector configured to select the at least one internet audio signal source, wherein a first audio signal is output from the selected internet audio signal source;
a receiver configured to receive a radio signal and output a second audio signal which is derived from the radio signal and is identical in content with the first audio signal;
a comparator operably coupled to the radio interface and the receiver, the comparator configured to compare a reception quality for the first audio signal and the second audio signal for determining an assessed reception quality; and
a multiplexer operably coupled to the radio interface, the receiver and the comparator, the multiplexer configured to output an audio signal output depending on the assessed reception quality of the first audio signal and the second audio signal.

11. The mobile internet radio receiver according to claim 10, wherein the radio signal is selected from the group consisting of a digital radio signal and an analog radio signal.

12. The mobile internet radio receiver according to claim 10, wherein the receiver further comprises a first receiver part configured to receive a digital radio signal, and a second receiver part configured to receive an analog radio signal.

13. The mobile internet radio receiver according to claim 10, wherein the second audio signal is applied to the audio signal output only for as long as the reception quality of the first audio signal is assessed as being insufficient.

14. The mobile internet radio receiver according to claim 10, wherein the first audio signal is applied to the audio signal output only for as long as the reception quality of the second audio signal is assessed as being insufficient.

15. The mobile internet radio receiver according to claim 10 further comprising a detector configured to determine whether the first and the second audio signals are identical in content based on a sender code contained in the radio signal.

16. The mobile internet radio receiver according to claim 10, wherein the assessed reception quality is based on a rate of interruptions or bit errors of the first and the second audio signals, and the audio signal output comprises one of the first and second audio signals having the lower interruption or bit error rate.

17. The mobile internet radio receiver according to claim 10, wherein the assessed reception quality is based on detection of a change-over of the radio interface from one cell of the mobile phone network to another cell, and the audio signal output is switched over to the second audio signal during the change-over.

18. The mobile internet radio receiver according to claim 10 further comprising a buffer for at least one of the first and second audio signals.

19. The mobile internet radio receiver according to claim 18, further comprising a controller configured to control the buffer in accordance with a detected time offset between the first audio signal and the second audio signal.

20. The mobile internet radio receiver according to claim 18, wherein in case of a buffer underrun of one of the first and second audio signals, the respectively other audio signal is applied to the audio signal output.
